(19) United States
(12) Patent Application Publication
(10) Pub. No.: US 2006/0279494 A1
(43) Pub. Date: Dec. 14, 2006

(54) COLOR COMPENSATION SYSTEM AND COLOR COMPENSATION METHOD FOR A DISPLAY

(76) Inventors: I-Hwei Yen, Taipei County (TW); Chia-Lin Liu, Taichung County (TW); Shih-Min Wu, Yilan County (TW); Chi-Neng Mo, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/160,174

(22) Filed: Jun. 13, 2005

(51) Int. Cl. G09G 3/34

(52) U.S. Cl. 345/84

(57) ABSTRACT

A color compensation system for a display including least one display panel and a light source is provided. The system includes a memory, a modulator and a controller. The memory stores a number of sets of gamma look up tables (LUTs) consisting of a color data. The modulator is electrically connected with the memory and the display panel. The controller is electrically connected with the memory and the light source. When the light source is turned on, the controller counts the use time of the light source. When the use time reaches a first predetermined value, the controller selects one of the sets of gamma look up tables (LUTs) in the memory and provides the color data of the set of gamma look up table to the modulator, and the modulator provides a driving voltage to the display panel by using the color data.

### BACKGROUND OF THE INVENTION

1. Field of the Invention

The present invention generally relates to a color compensation system and a color compensation method for a display. More particularly, the present invention relates to an automatic color compensation system and an automatic color compensation method for a projection display.

2. Description of Related Art

In most display device, a color image to be displayed is mixed by the three primary colors red (R), green (G) and blue (B). For projection displays, a lamp is used as the light source and the light emitting from the lamp passing through a color management system to generate images to display. Since the characteristics of R, G, B wavelength in the white light emitting from the lamp are different, the degree of decayed of each R, G, B light is different when lamp decays. Conventionally, in order to correct a white balance, light meters or sensors may be used inside or outside the displays in some cases so that the projected light from each display panel can be measured, and the white balance can be corrected.

However, the above mentioned method has disadvantages of requiring additional light meters or sensors. That may increase the protection display manufacturing cost and manufacturing complexity.

### SUMMARY OF THE INVENTION

Accordingly, the present invention is directed to a color compensation system for a display capable of correcting the white balance.

The present invention is directed to a color compensation method for a display in which additional light meters or sensors are not required.

According to an embodiment of the present invention, a color compensation system for a display comprising least one display panel and a light source is provided. The system comprises a memory, a modulator and a controller. The memory stores a number of sets of gamma look up tables (LUTs) consisting of a color data. The modulator is electrically connected with the memory and the display panel. The controller is electrically connected with the memory and the light source. When the light source is turned on, the controller counts the use time of the light source. When the use time reaches a first predetermined value, the controller selects one of the sets of gamma look up tables (LUTs) in the memory and provides the color data of the set of gamma look up table to the modulator, and the modulator provides a driving voltage to the display panel by using the color data.

According to an embodiment of the present invention, the color data comprises a red color data, a green color data and a blue color data.

According to an embodiment of the present invention, the light source is a white light lamp.

According to an embodiment of the present invention, when the use time exceeds a second predetermined value, the controller selects another set of gamma LUTs from the memory for the modulator.

According to an embodiment of the present invention, each display panel is a liquid crystal on silicon (LCoS) panel.

According to another embodiment of the present invention, a color compensation method for a display comprising least one display panel and a light source is provided. The method comprises the steps of starting to count a first use time of the light source when the light source is turned on, and stopping counting the first use time of the light source when the light source is turned off; and changing gamma look up tables (LUTs) if the first use time of the light source exceeds a first predetermined time, and resetting the counted use time simultaneously.

According to an embodiment of the present invention, after resetting the counted use time, a second use time of the light source is started to count when the light source is turned on again, and the second use time of the light source is stopped counting when the light source is turned off.

According to an embodiment of the present invention, if the second use time of the light source exceeds a second predetermined time, changing again gamma look up tables (LUTs).

In the present invention, the use time of the light source is counted and when the use time of the light source exceeds a predetermined value, the gamma look up tables (LUTs) are changed so that the white balance can be corrected as the light source decays. In addition, the color compensation method and system are automatic and no additional light meters or sensors are required in the present invention so that the display manufacturing cost and manufacturing complexity are not increased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing a color compensation system for a display according to an embodiment of the present invention.

FIG. 2 is a flow chart showing a color compensation method for a display according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

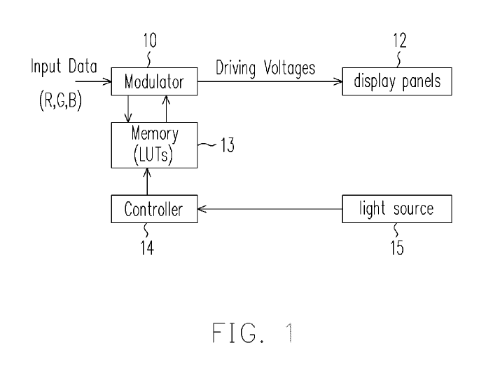

FIG. 1 is a block diagram showing a color compensation system for a display according to an embodiment of the present invention. As shown in FIG. 1, the color compensation system comprises a modulator 10, a memory 13 and a controller 14. The display is a projection display and comprises at least one display panel 12 and a light source 15. In an embodiment, the display further comprises several optical elements, such as optical filters, light beam splitter and optical films. The display panel 12 is, for example, liquid crystal on silicon (LCoS) panel. In a preferred embodiment, the display panels 12 comprise a red (R) display panel, a green (G) display panel and a blue (B) display panel. The light source 15 is a white light lamp, for example.

Usually, since the characteristics of R, G, B wavelength in the white light emitting from the light source 15 are different, the degree of decayed of each R, G, B light is different when the light source 15 decays. In the other word, as the light source 15 decays, the color of the displayed image is shifted because the degree of decayed of each R, G, B light is different. Hence, the color correction is required for maintaining good displaying quality. In the present invention, the color compensation system of FIG. 1 is used to correct the color when the light source decays.

As shown in FIG. 1, in the system, the modulator 10 receives color data, such as R, G, B color data, and checks the current active gamma LUTs (R, G, B) to make a translation between gray and driving voltages. Then, the driving voltages are input to the display panel 12 from the modulator 10. The memory 13 is electrically connected with the modulator 10 and stores a number of pre-generated sets of gamma look up tables (LUTs) of color data, such as R, G, B gamma LUTs. The controller 14 is electrically connected with the memory 13 and the light source 15. The controller 14 records the total use time of the light source 15 by counting the time interval between the light source 15 turned on and turned off. In the other word, when the light source 15 is turned on, the controller 14 starts to count a use time of the light source 15, and when the light source 15 is turned off, the controller 14 stops counting the use time of the light source 15.

When the total use time exceeds a first predetermined value of light source usage, the controller 14 selects one of the sets of gamma LUTs from the memory 13 for the modulator 10, and then the modulator 10 inputs a new set of driving voltages to the display panels 12. When the use time exceeds a second predetermined value, the controller 14 selects another set of gamma LUTs from the memory for the modulator 10. Therefore, the modulator 10 always uses corrected gamma LUTs to make translation of input data to output data. These sets of gamma LUTs can be produced through several simulating experiments or collecting historical data. The gamma LUTs are display system specific. For example, different types of light source have different gamma LUTs, and different types of light engines have different gamma LUTs. Usually, a display product always uses the same type of the light source and light engine so that the gamma LUTs that display system specific are acceptable.

In the present invention, the color compensation method comprises the steps of starting to count a first use time of the light source when the light source is turned on, and stopping counting the first use time of the light source when the light source is turned off; and changing gamma look up tables (LUTs) if the first use time of the light source exceeds a first predetermined time, and resetting the counted use time simultaneously. In an embodiment, after resetting the counted use time, a second use time of the light source is started to count when the light source is turned on again, and the second use time of the light source is stopped counting when the light source is turned off. If the second use time of the light source exceeds a second predetermined time, changing again gamma look up tables (LUTs).

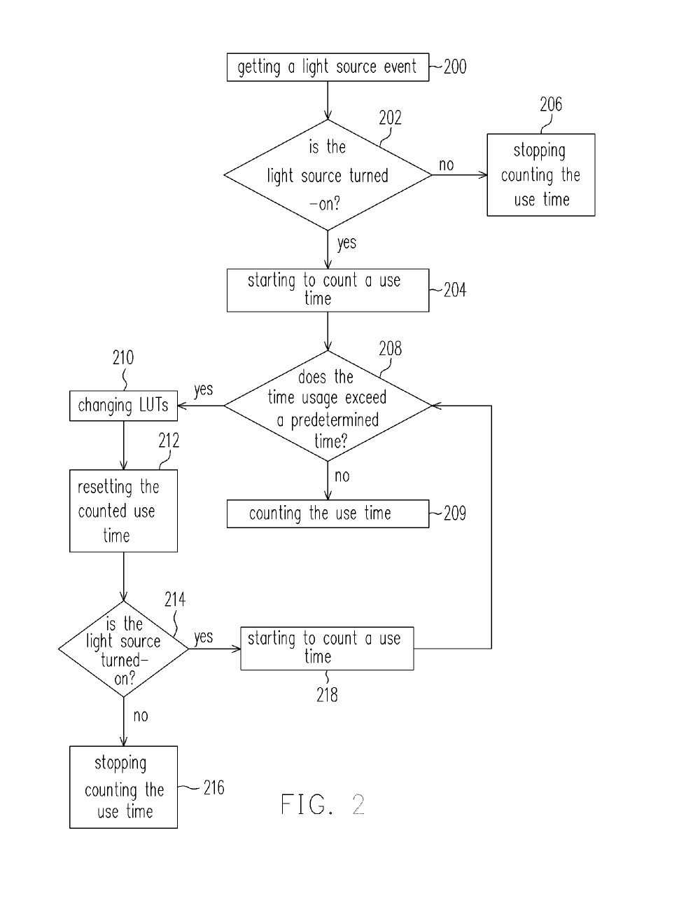

The detail flow chart of the color compensation method is as shown in FIG. 2. As shown in FIG. 2, a step of getting a light source event (step 200) is performed. Then, determining whether the light source is turned on (step 202). If the light source is turned on, a use time is started to count (step 204). If the light source is turned off, the use time is stopped counting (step 206). Such that the total use time of the light source is recorded by counting the time interval between the light source turned on and turned off.

Next, a step of determining whether the use time exceeds a predetermined time (step 208) is carried out. If the use time does not exceed the predetermined time, the use time is continued to count (step 209). If the use time exceeds the predetermined time, the gamma LUTs is changed (step 210). In details, a new set of gamma LUTs is selected and used. When the gamma LUTs is changed, the counted use time will be reset (step 212). In the other words, the use time will be counts again.

After the step of 212, a step of determining whether the light source is turned on (step 214) is carried out. If the light source is turned on, a use time is started to count (step 218). If the light source is turned off, the use time is stopped counting (step 216). Such that the next stage total use time of the light source is also recorded. Similarly, after the step 218, returning to the step 208 that is determining whether the use time exceeds a predetermined time for checking whether the light source decays again.

The use time of the light source is counted and when the use time of the light source exceeds a predetermined value, the gamma look up tables (LUTs) are changed so that the white balance can be corrected as the light source decays. Therefore, the display using the color compensation system and method always corrects the displayed image color even though the total luminescence from the light source decays as time goes by.

In addition, the color compensation method and system are automatic and no additional light meters or sensors are required in the present invention so that the display manufacturing cost and manufacturing complexity are not increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color compensation system for a display comprising least one display panel and a light source, the system comprising:
a memory, storing a number of sets of gamma look up tables (LUTs) consisting of a color data;
a modulator, electrically connected with the memory and the display panel;
a controller, electrically connected with the memory and the light source,
wherein when the light source is turned on, the controller counts the use time of the light source, and
when the use time reaches a first predetermined value, the controller selects one of the sets of gamma look up tables (LUTs) in the memory and provides the color data of the set of gamma look up table to the modulator, and the modulator provides a driving voltage to the display panel by using the color data.

2. The system of claim 1, wherein the color data comprises a red color data, a green color data and a blue color data.

3. The system of claim 1, wherein the light source is a white light lamp.

4. The system of claim 1, wherein when the use time exceeds a second predetermined value, the controller selects another set of gamma LUTs from the memory for the modulator.

5. The system of claim 1, wherein the display panel is a liquid crystal on silicon (LCoS) panel.

6. A color compensation method for a display comprising least one display panel and a light source, the method comprising:
starting to count a first use time of the light source when the light source is turned on, and stopping counting the first use time of the light source when the light source is turned off; and
changing gamma look up tables (LUTs) if the first use time of the light source exceeds a first predetermined time, and resetting the counted use time simultaneously.

7. The method of claim 6, wherein after resetting the counted use time, a second use time of the light source is started to count when the light source is turned on again, and the second use time of the light source is stopped counting when the light source is turned off.

8. The method of claim 7, wherein if the second use time of the light source exceeds a second predetermined time, changing again gamma look up tables (LUTs).
